(19) United States
(12) Patent Application Publication
(10) Pub. No.: US 2015/0035309 A1
(43) Pub. Date: Feb. 5, 2015

(54) Solid, hard top cover for a Jeep storage device

(71) Applicant: John T. Clark, Noblesville, IN (US)

(72) Inventor: John T. Clark, Noblesville, IN (US)

(21) Appl. No.: 14/336,451

(22) Filed: Jul. 21, 2014

Related U.S. Application Data
(60) Provisional application No. 61/857,274, filed on Jul. 23, 2013.

(51) Int. Cl. B60J 7/16

(52) U.S. Cl. CPC B60J 7/1621
USPC 296/100.07

(57) ABSTRACT

A solid, hard top cover device for a Jeep storage area. It is a security enclosure for the open storage space behind the back seat and in front of a hinged tailgate deck of a Jeep vehicle. The device includes a deck; a way to secure the deck to the storage area and structure of the jeep; a top pivoting lid 33; a manner for pivoting; and a manner for sealing the lid and the deck so that the device can provide a solid top to the storage area of a jeep protected with roll bars.

### CROSS-REFERENCE TO RELATED APPLICATIONS

This application claims the benefit of Provisional Patent Application Ser. No. 61/857,274 filed Jul. 23, 2013 by John T. Clark and entitled “A solid, hard top cover for a Jeep storage device”.

### FIELD OF INVENTION

This invention relates to a solid, hard top cover for a Jeep® storage device. The present invention relates in general to covers and security enclosures for use in open deck vehicles for sport utility and similar vehicles, such as Jeeps and others, which have an open storage space behind the back seat and in front of a hinged tailgate. This invention generally is used to create a secured cargo area. This disclosure relates more particularly to off-road vehicles and more specifically to open top Jeep® brand vehicles and to deployable and retractable hard tops for the storage area for such vehicles.

### FEDERALLY SPONSORED RESEARCH

None.

### SEQUENCE LISTING OR PROGRAM

None.

### BACKGROUND-FIELD OF INVENTION AND PRIOR ART

### Problem Solved

Off-road vehicles such as the Jeep® Wrangler® and CJ® are popular among outdoor enthusiasts because of their rugged build and appearance and consequent ability to move over terrain where other vehicles cannot tread. The Wrangler® and CJ® models have open passenger compartments and an open rear compartment. Factory soft storage cover tops are available for these vehicles that can be manually attached to the vehicle with snaps, a belt rail system, locking tabs, and the like to enclose the passenger and rear compartments. Factory tops, however, are cumbersome to install and can require several minutes for complete deployment. Also, they do not afford the security of a lockable hardtop cover as described in this Clark Invention.

### PRIOR ART

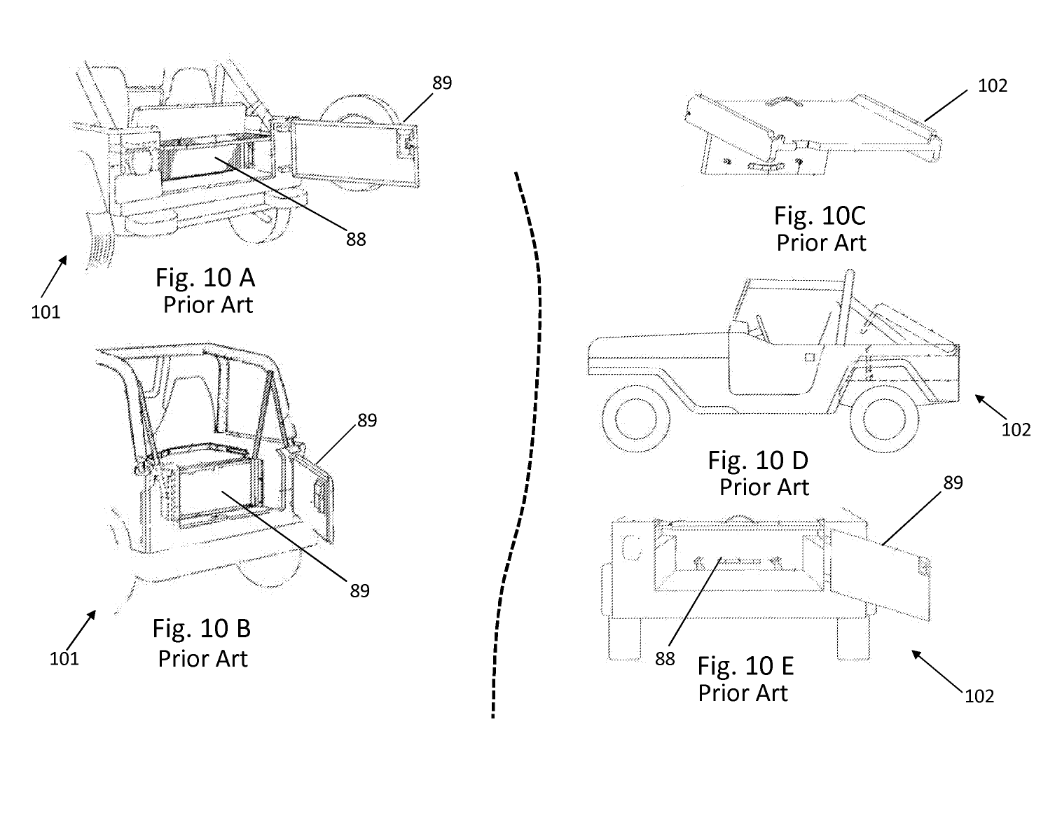

As far as known, there are no solid, hard top covers for a Jeep storage device or the like. FIG. 10 through FIG. 13 show prior art attempts to provide solutions to the hard top cover for the storage area on jeeps. It is believed that this product is unique in its design and technologies from any prior attempts.

Prior art 101 U.S. Pat. No. 5,324,089 issued to Schlachter in 1994 and entitled a “Convertible security enclosure for open deck vehicle” shows a security enclosure is mounted on the open load deck of a jeep between the rear seat and the tailgate. The load deck, deck sidewalls, and tailgate provide four sidewalls of the security compartment. The top enclosure panel is releasably locked to the load deck side panels by spring loaded lock pins which are concealed within the security compartment. According to this arrangement, is more complex and costly than the Clark embodiment. Next, prior art 102 U.S. Pat. No. 5,564,768 issued to Saffold in 1996 and entitled “Portable security trunk for utility vehicles and trucks” demonstrates a portable trunk apparatus that creates a large, fully enclosed and secure trunk in the rear bed of trucks and sports utility vehicles. In accordance with the preferred embodiment of the present invention, the portable trunk apparatus is removably manually installable in and removably manually extractable from the truck without using tools. The portable trunk apparatus includes a top wall and a front wall connected together along edges thereof such that a completely enclosed trunk is formed in the rear of the truck when the present invention is properly installed above the floor and in front of the rear wall (and rear gate door) of the truck. It also is far more complexity than the Clark device presented herein.

Prior art 103 U.S. Pat. No. 7,438,338 was issued to Schumacher, et al. in 2008 is another device. It is entitled “Multi-positional storage arrangement for a sport utility or other vehicle” and presents a multi-positionable storage arrangement with removable front and top panels that can be configured in a number of ways between two side panels to form a variety of both secured and open storage spaces. In the preferred configurations, the front, top, and side panels of the arrangement combine with the rear deck and tailgate of the vehicle to enclose a securable storage space. In use, the front panel can be slid substantially vertically into one of three sets of grooves in the side panels. One or more of the top panels can thereafter be slid horizontally in grooves in the side panels until the forward most top panel abuts and overlaps the front panel. It fails to provide the pivotal lid and ease of use embodied with the Clark device. Further prior art 104 U.S. Pat. No. 8,256,819 was issued to Gregory in 2012 and is entitled “Security deck enclosure system”. It anticipates a system and method for creating a storage enclosure in a vehicle having a cargo area defined by a floor a pair of spaced apart side panels and a tailgate is disclosed. The system includes a forward bushing that is mounted from the top panel and an aft bushing that is also mounted from the top panel at a distance from the forward bushing. The system the tailgate and a locking mechanism to create a lockable, secure space. It requires more parts and is more complex in form than the Clark embodiment.

Prior art 105 U.S. Pat. No. 6,113,179 was issued to Szigeti in 2000 and is entitled “Vehicle security enclosure lit”. It presents a vehicle security enclosure kit consists of a readily removable L-shaped storage area enclosure panel, mounting platforms and fasteners to connect the platforms to an open deck vehicle and fasteners to connect the panel to the platforms. When the panel is mounted, a security enclosure is created between the back seat, side walls, deck, and tailgate of the vehicle. The L-shaped storage area enclosure panel consists of a top horizontal panel and a bottom vertical panel. The horizontal panel is mounted onto the platforms and the vertical panel extends from the horizontal panel at an angle such that it is parallel to the back seat. It fails to be as pivotal and useable as the Clark device. And then there is prior art 106 U.S. Pat. No. 6,305,730 issued to Stone in 201 and entitled “Vehicle storage trunk creation system”. It shows a storage trunk creation system for a vehicle having a load deck, deck sidewalls and a tailgate. The storage trunk creation system is securely mounted on a jeep style vehicle between the back of the front seats and the rear tailgate, and from one side of the jeep sidewall to the other. It is more complex with many parts as compared to the Clark device.

### SUMMARY OF THE INVENTION

This invention is a solid, hard top cover for a Jeep storage device. The preferred embodiment is a hard top cover device 30 over a jeep storage area 88 that is comprised of: (a) a deck 34; (b) a means 46 to secure deck 34 to the storage area 88 and structure/sides of jeep; (c) a top pivoting surface/lid 33; (d) a means 41 for pivoting—hinge means with a shaft 42 and with or without spring and/or dampener for rotation of the lid 33 around the shaft 42 and to/from a plane of deck 34; (e) a manner or means 41A to connect pivot means for pivoting 41 to lid 33; (f) a pivot plate means 40 (side structure) for rotatably securing means for pivoting means 41 and the shaft 42 to the deck 34; (g) a means for sealing 44 (gasket or the like) the lid 33 and the deck 34; and (h) a handle 38 and locking 39 means connected to the lid 33 wherein the device may provide a solid top to the storage area of a jeep or of another vehicle protected with roll bars.

The newly invented solid, hard top cover for a Jeep storage device may be manufactured at low volumes by very simple means and in high volume production by more complex and controlled systems.

### Objects and Advantages

There are several objects and advantages of the solid, hard top cover for a Jeep storage device. There are currently no known heavy duty application heating mats that are effective at providing the objects of this invention. The advantages and benefits include:

TABLE A
Advantages and Benefits

| Item | Advantages |
|---|---|
| 1 | Fast use of storage compartment |
| 2 | Secured storage (vs. soft cover) |
| 3 | Deck support for carrying additional |
| | coverage |
| 4 | Aesthetic diamond plate surface |
| 5 | Added storage space around roll bars |

Finally, other advantages and additional features of the present solid, hard top cover for a Jeep storage device will be more apparent from the accompanying drawings and from the full description of the device. For one skilled in the art of covers for vehicle storage and truck beds and the like, it is readily understood that the features shown in the examples with this product are readily adapted to other types of hardtop cover systems and devices.

### DESCRIPTION OF THE DRAWINGS

### Figures

The accompanying drawings, which are incorporated in and constitute a part of this specification, illustrate an embodiment of the solid, hard top cover for a Jeep storage device that is preferred. The drawings together with the summary description given above and a detailed description given below serve to explain the principles of the solid, hard top cover for a Jeep storage device. It is understood, however, that the solid, hard top cover for a Jeep storage device is not limited to only the precise arrangements and instrumentalities shown.

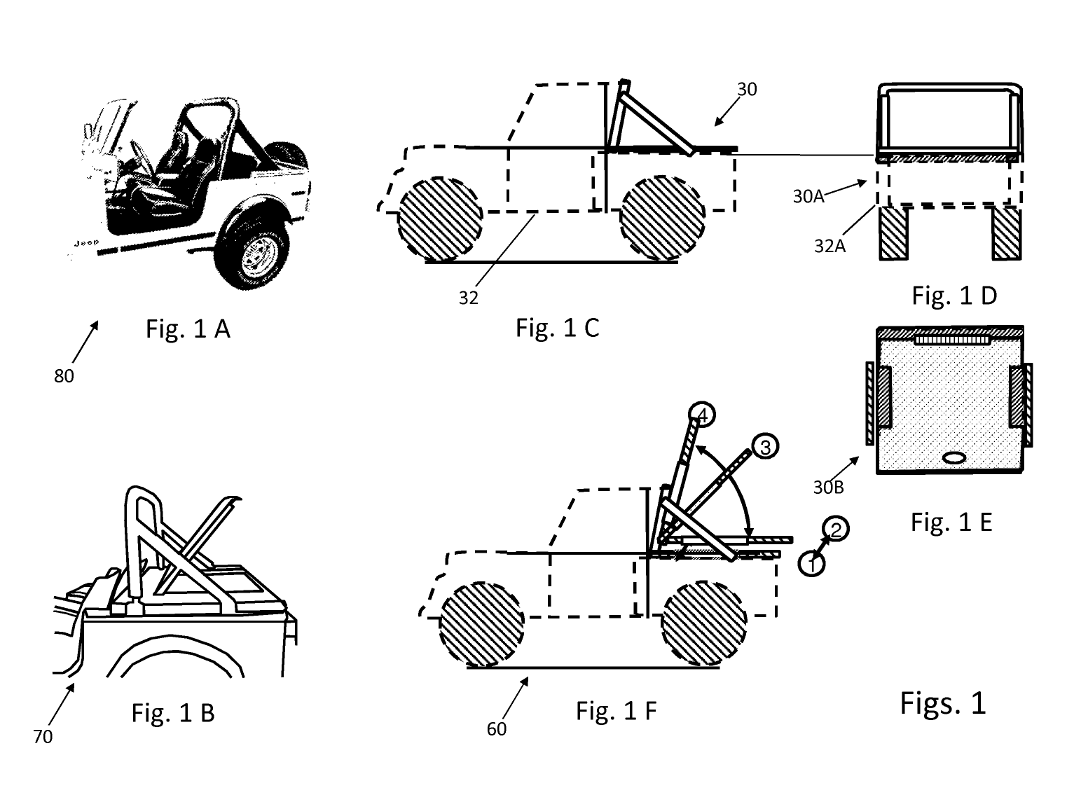

FIGS. 1 A through 1 F show the general configurations of the hard top jeep cover over storage device.

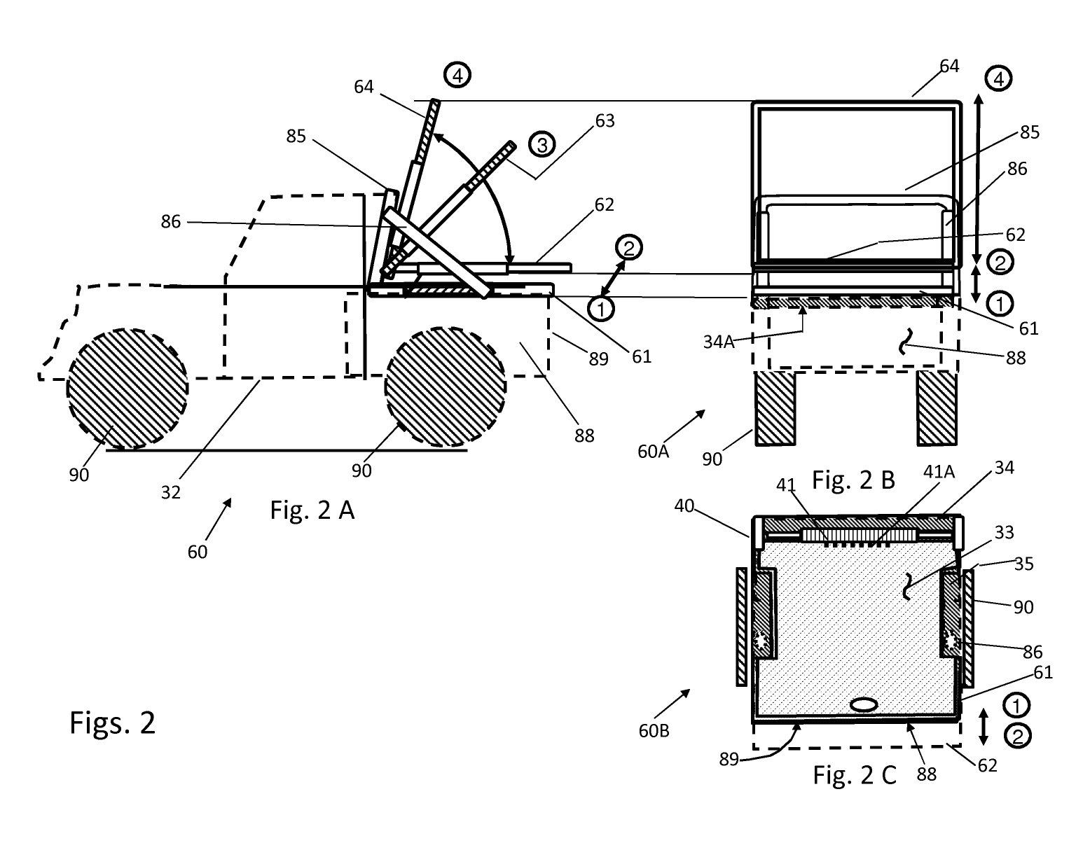

FIGS. 2 A through 2 C show the operation and positions of the hard top jeep cover device over storage space.

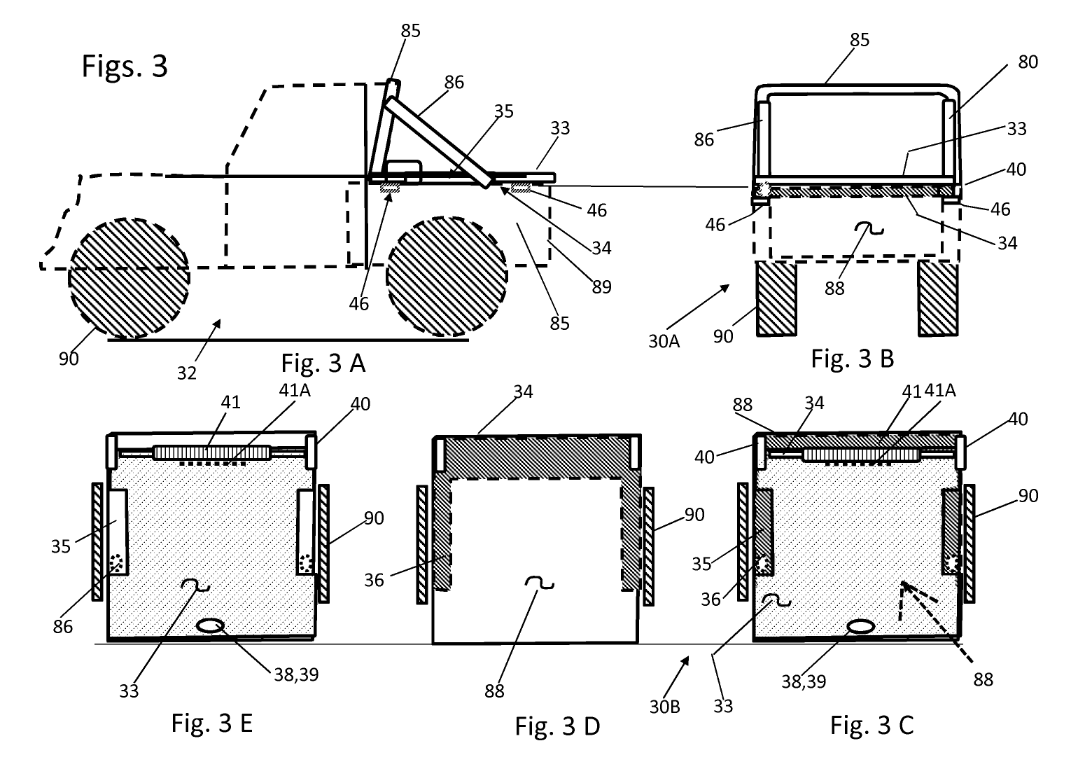

FIGS. 3 A through 3 E show side, end, and top views of the jeep cover device for secure storage space.

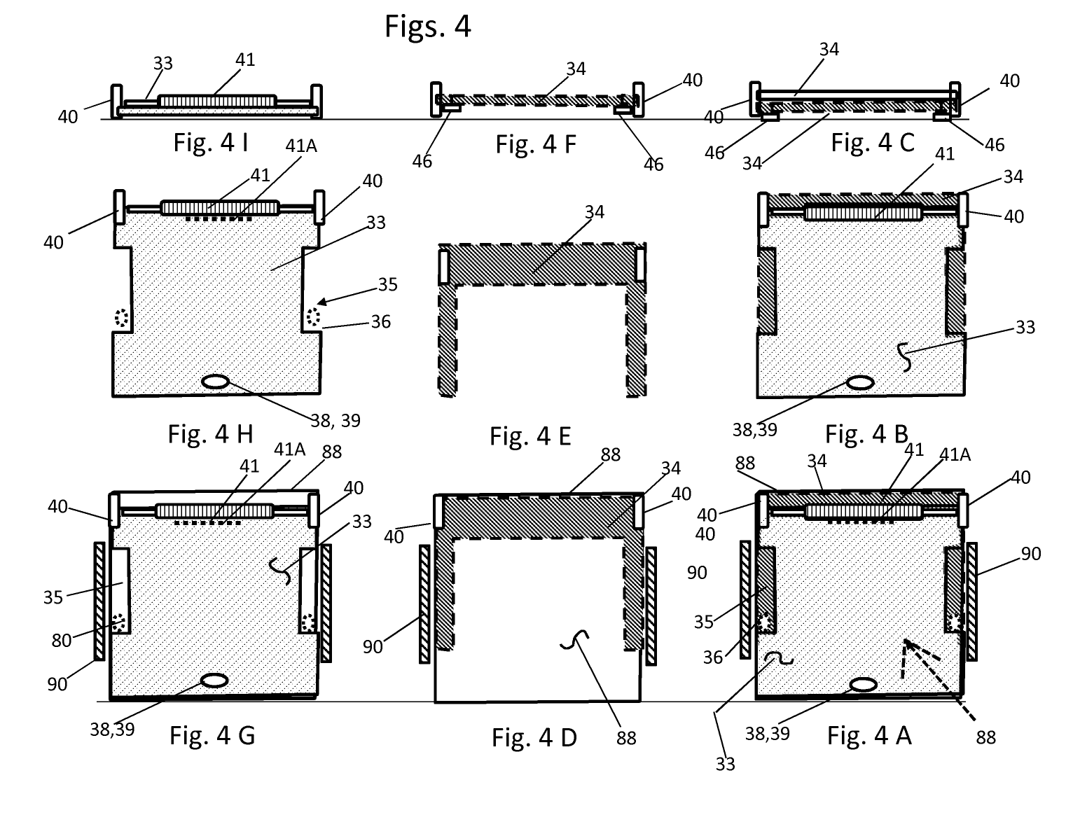

FIGS. 4 A through 4 I show detail of the components for the jeep cover device for secure storage space.

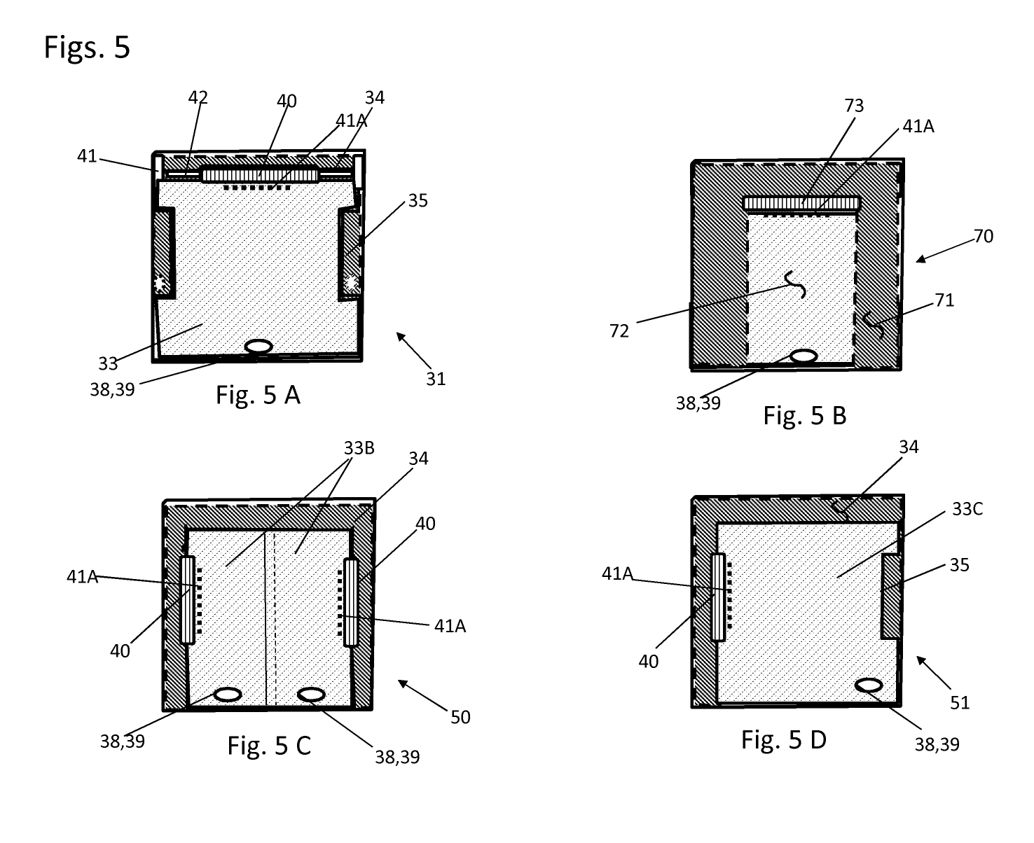

FIGS. 5 A through 5 D show alternative embodiments for the jeep solid cover device.

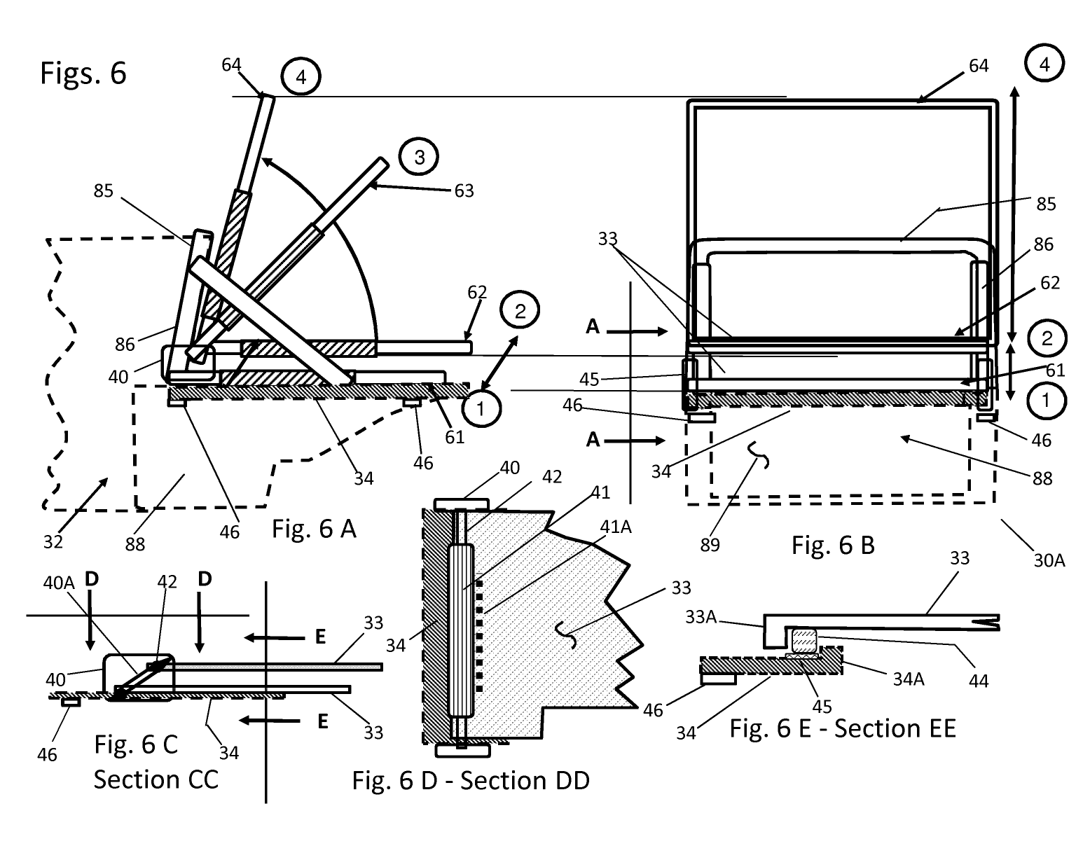

FIGS. 6 A through 6 E show an example of hinge and overlap on the jeep hard top cover device.

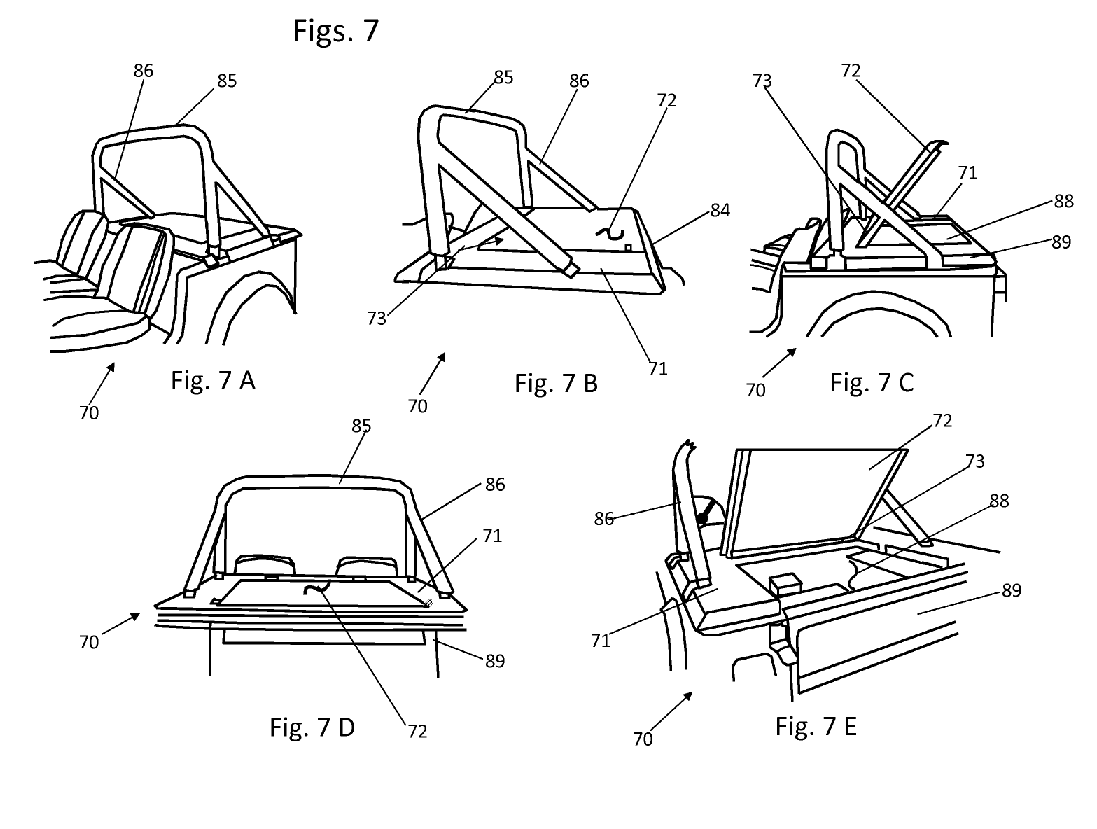

FIGS. 7 A through 7 E show some prototype examples of the hard top cover device.

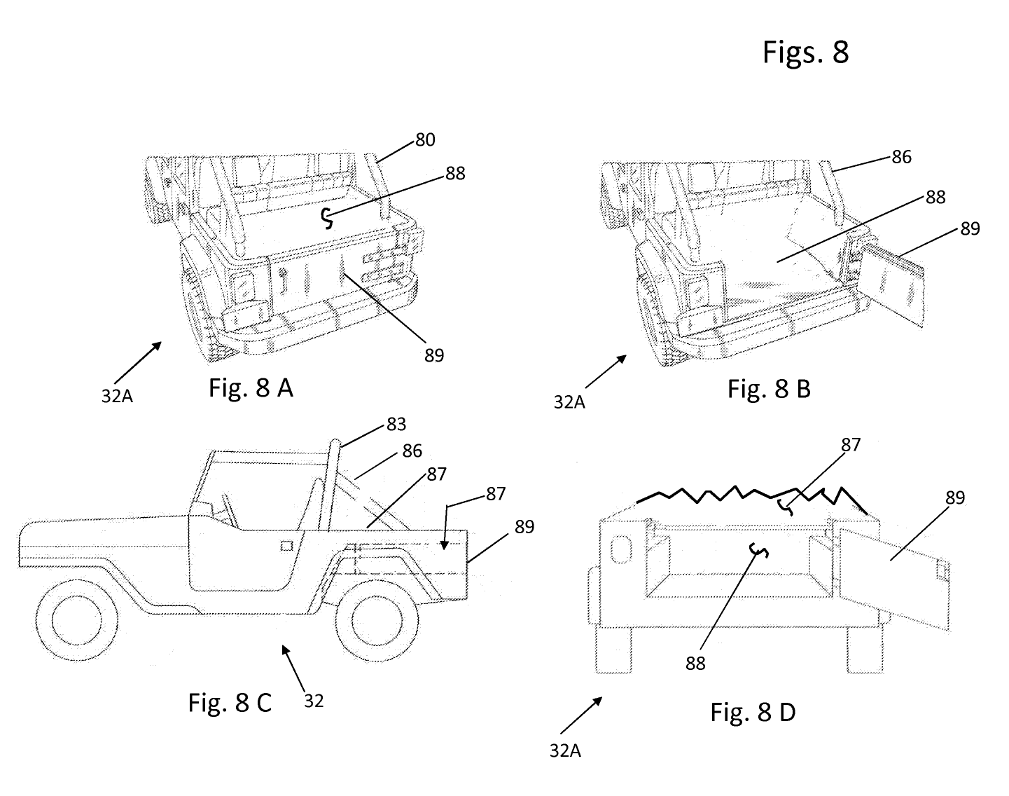

FIGS. 8 A through 8 D show sketches of a typical jeep with jeep with roll bars needing a cover device.

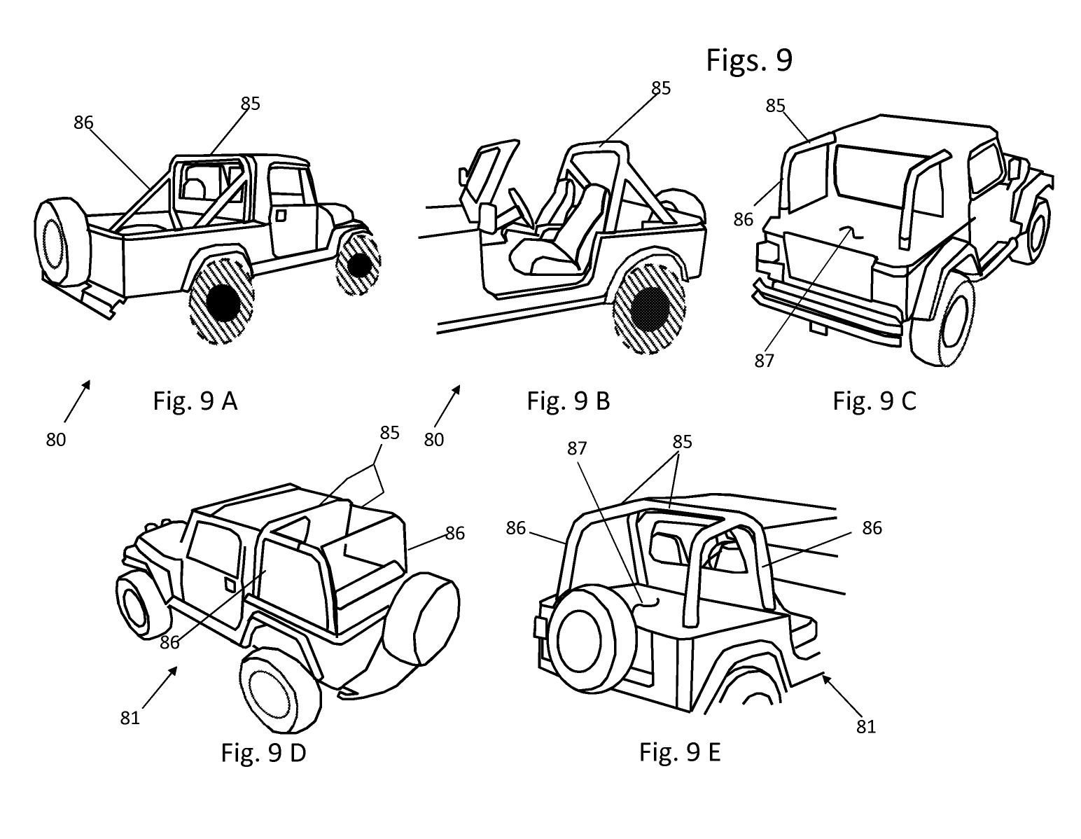

FIGS. 9 A through 9 E show various sketches of jeeps configured with roll bars.

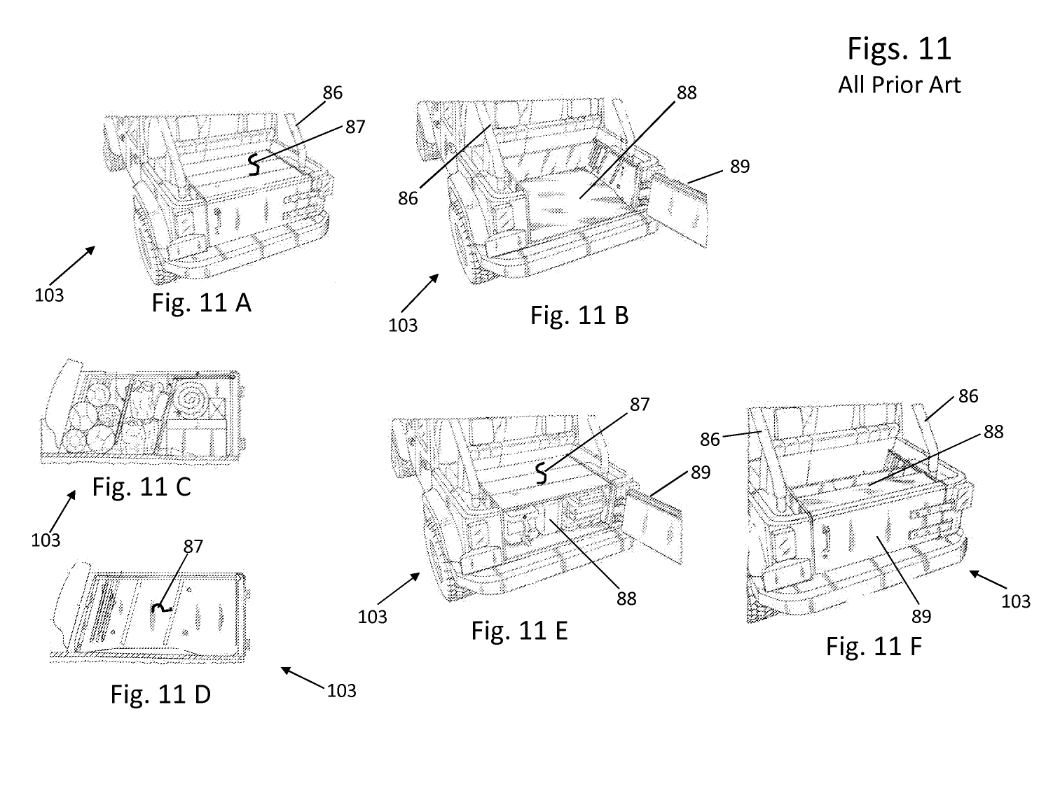

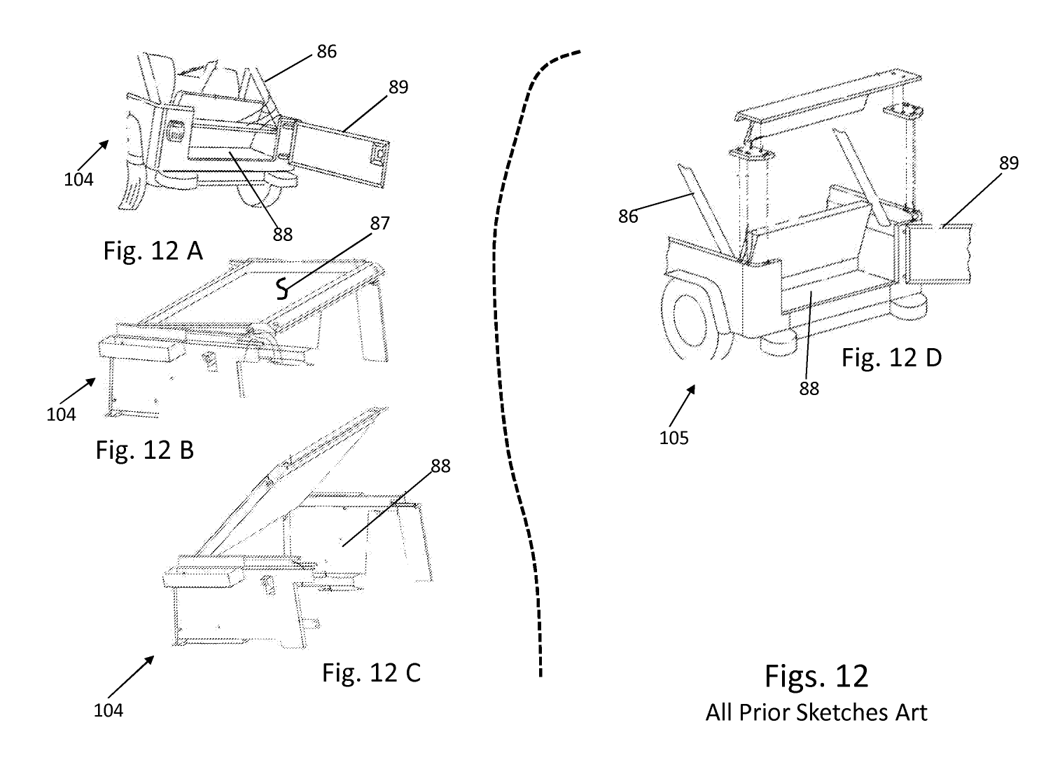

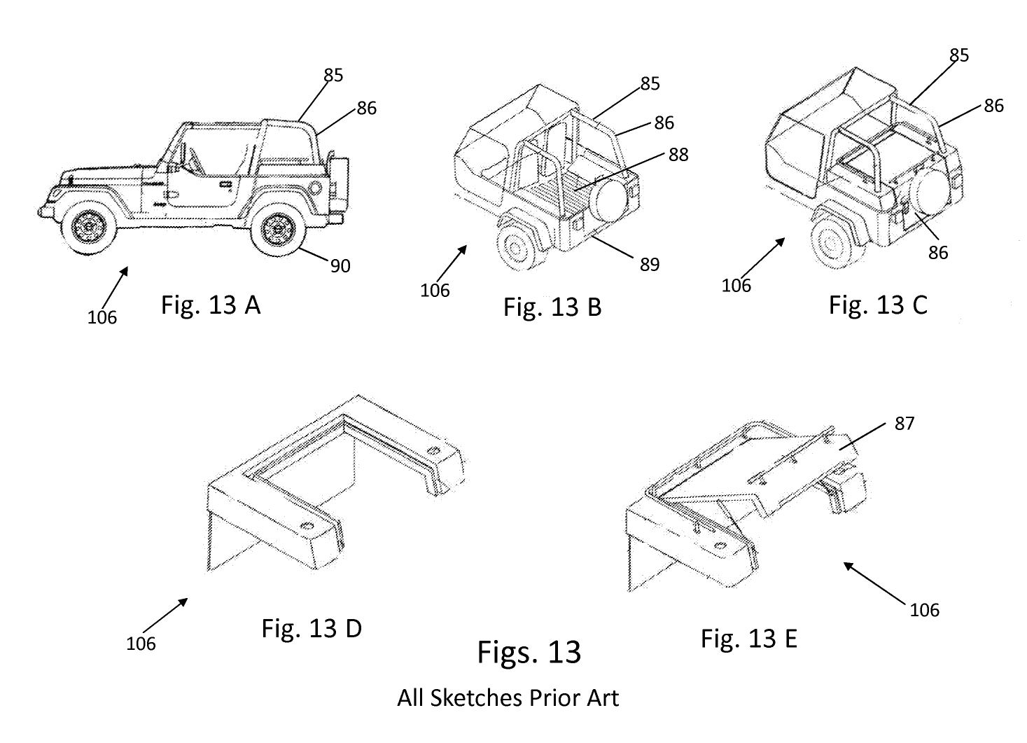

FIGS. 10 A through 10 E; FIGS. 11 A through 11 F; FIGS. 12 A through 12 D; and FIGS. 13 A through 13 E show prior art attempts to provide solutions to the hard top cover for the storage area on jeeps.

### DESCRIPTION OF THE DRAWINGS

### Reference Numerals

The following list refers to the drawings:

TABLE B
Reference numbers

| Ref # | Description |
|---|---|
| 30 | General hard top cover device over jeep storage |
| | unit |
| 30A | Back view of hard top cover device |
| 30B | Top View of typical jeep |
| 32 | Side/Side view of typical jeep |
| 32A | Back and perspective sketch of jeep |
| 33 | Top pivot surface/lid |
| 33A | Lid labyrinth lip |
| 33B | Bi-fold opening lid |
| 33C | Side open lid |
| 34 | Deck |
| 34A | Deck labyrinth lip |
| 35 | Roll bar structure recess/aperture |
| 36 | Roll bar fitted to deck |
| 38 | Handle means - recessed, loop, or the like |
| 39 | Locking means (not show) |
| 40 | Pivot means (side) structure for rotatably |
| | securing Pivot means 41 and shaft 42 to deck 34 |
| 40A | Slot/Aperture in plate |
| 41 | Means for pivoting - hinge means with or |
| | without spring or dampener for rotation of lid |
| | 33 around the shaft 42 and to/from deck 34 |
| 41A | Manner or means for securely connecting pivot |
| | means for pivoting 41 to lid 33 |
| 42 | Pivot shaft |
| 44 | Means for sealing (gasket or the like) |
| 45 | Means for securing gasket 44 to deck 34 |
| 46 | Means for securing deck 34 to storage area 88 |
| | structure/sides of jeep |
| 50 | Bi-fold Lid |
| 51 | Side opening lid |
| 60 | Operation device |
| 60A | Back view of operation of device |
| 60B | Top view of operation of device |
| 61 | Closed position - 1, flat and sealed |
| 62 | Rotated position - 2, raised and ready to |
| | pivot |
| 63 | Pivot Position (approximately 45 Degrees) - 3, |
| | mid pivot, partially open |
| 64 | Pivot Position (approximately 75 to 90 Degrees) - |
| | 4, Full open |
| 70 | Prototype hardtop jeep cover system |
| 71 | Prototype Deck |
| 72 | Prototype Lid |
| 73 | Prototype Hinge means |
| 80 | General jeep photograph sketch (with short |
| | roll bar) |
| 81 | General jeep photograph sketch (with full |
| | seating) |
| 85 | Roll Bar |
| 86 | Roll bar support leg |
| 87 | Soft cover |
| 88 | Storage area |
| 89 | Rear gate/door |
| 90 | Tires |
| 101 | Prior art U.S. Pat. No. 5,324,089 |
| 102 | Prior art U.S. Pat. No. 5,564,768 |
| 103 | Prior art U.S. Pat. No. 7,438,338 |
| 104 | Prior art U.S. Pat. No. 8,256,819 |
| 105 | Prior art U.S. Pat. No. 6,113,179 |
| 106 | Prior art U.S. Pat. No. 6,305,730 |

### DETAILED DESCRIPTION OF PREFERRED EMBODIMENT

The present development is a solid, hard top cover for a Jeep storage device. This invention relates to a solid, hard top cover for a Jeep® storage device. The present invention relates in general to covers and security enclosures for use in open deck vehicles for sport utility and similar vehicles, such as Jeeps and others, which have an open storage space behind the back seat and in front of a hinged tailgate. This invention generally is used to create a secured cargo area. This disclosure relates more particularly to off-road vehicles and more specifically to open top Jeep® brand vehicles and to deployable and retractable hard tops for the storage area for such vehicles.

The advantages for the solid, hard top cover for a Jeep storage device 30 are listed above in the introduction. Succinctly the benefits are that the device:
Fast use of storage compartment
Secured storage (vs. soft cover)
Deck support for carrying additional coverage
Aesthetic diamond plate surface
Added storage space around roll bars

The preferred embodiment is a hard top cover device 30 over a jeep storage area 88 that is comprised of: (a) a deck 34; (b) a means 46 to secure deck 34 to the storage area 88 and structure/sides of jeep; (c) a top pivoting surface/lid 33; (d) a means 41 for pivoting—hinge means with a shaft 42 and with or without spring and/or dampener for rotation of the lid 33 around the shaft 42 and to/from a plane of deck 34; (e) a manner or means 41A to connect pivot means for pivoting 41 to lid 33; (f) a pivot plate means 40 (side structure) for rotatably securing means for pivoting means 41 and the shaft 42 to the deck 34; (g) a means for sealing 44 (gasket or the like) the lid 33 and the deck 34; and (h) a handle 38 and locking 39 means connected to the lid 33 wherein the device may provide a solid top to the storage area of a jeep or of another vehicle protected with roll bars.

There is shown in FIGS. 1-13 a complete description and operative embodiment of the solid, hard top cover for a Jeep storage device. In the drawings and illustrations, one notes well that the FIGS. 1-13 demonstrate the general configuration and use of this product. The various example uses are in the operation and use section, below.

The accompanying drawings, which are incorporated in and constitute a part of this specification, illustrate an embodiment of the solid, hard top cover for a Jeep storage device 30 that is preferred. The drawings together with the summary description given above and a detailed description given below serve to explain the principles of the solid, hard top cover for a Jeep storage device 30. It is understood, however, that the device 30 is not limited to only the precise arrangements and instrumentalities shown. Other examples of hard top cover devices and uses are still understood by one skilled in the art of such cover device for vehicles to be within the scope and spirit shown here.

FIGS. 1 A through 1 F show the general configurations of the hard top jeep cover over storage device. FIGS. 1 A through 1 F are sketches of the general device 30. The sketches are from several views. Shown are the general hard top cover device 30 over jeep storage unit from a side view 32; a back view 30A of hard top cover device 30; a top view 30B of typical jeep; a side view of operation 60 of device 30; and a prototype hardtop jeep cover system 70. The device structural members may be made of various durable materials such as coated or plated metals, composite materials and other durable materials as one skilled in the art of special enclosures and accessories well appreciates. These include, for example and not as a limitation, aluminum, anodized aluminum, steel, chrome plated steel, stainless steel, powder coated steel, various composite materials and high strength reinforced materials.

FIGS. 2 A through 2 C show the operation and positions of the hard top jeep cover device over storage space. This is discussed in the operations section, below.

FIGS. 3 A through 3 E show side, end/back, and top views of the jeep cover device for secure storage space. Shown views from a back view 30A of hard top cover device 30, a top view 30B of typical jeep, and a side/side view 32 of typical jeep. The components shown throughout the views are: top pivoting surface/lid 33, a deck 34, a roll bar structure, the recess/aperture 35 in the deck 33 permitting clearance of the support bar 86 as the deck is opened and closed, the configuration of the roll bar fitted to deck 36, a handle means 38—recessed, loop, or the like, a locking means (details not show) 39, the pivot plate means 40 (side) structure for rotatably securing pivot means 41 and shaft 42 to deck 34, a means 41 for pivoting—hinge means with a shaft 42 and with or without spring and/or dampener for rotation of the lid 33 around the shaft 42 and to/from deck 34, a manner or means 41A for connecting pivot means 41 to lid 33, the pivot shaft 42, a means 46 for securing deck 34 to storage area 88 structure/sides of jeep, the roll Bar 85, the roll bar support leg 86, and the jeep storage area 88, rear gate/door 89, and tires 90.

The components may be comprised of a metal such as steel or aluminum and may be coated with a powder coat, paint, or other surface finish. They may also be made of a heavy duty, durable plastic or composite material. These components feature means such as apertures for receiving fasteners such as bolts or other fasteners. These means to fasten are used to removably secure the components to the storage area 88 of the vehicle (jeep or the like) [fasteners not shown]. The structural cross section of the components may be one of a plethora of designs such as “X” ribs, straight ribs, herringbone designs and the like. Of special note, the deck 34 and lid 33 anticipate chromed diamond plate as a surface finish as a preferred embodiment. Other finishes may be substituted as described above.

FIGS. 4 A through 4 I show detail of the components for the jeep cover device for secure storage space. The components have been described above and include: top pivoting surface/lid 33; deck 34; roll bar structure recess/aperture 35; roll bar fitted to deck 36; handle means 38—recessed, loop, or the like; locking means (not show) 39; pivot plate means 40 (side) structure for rotatably securing pivot means 41 and shaft 42 to deck 34; a means 41 for pivoting—hinge means with a shaft 42 and with or without spring and/or dampener for rotation of the lid 33 around the shaft 42 and to/from deck 34; manner or means 41A for connecting pivot means 41 to lid 33; pivot shaft 42; means 46 for securing deck 34 to storage area 88 and structure/sides of jeep, and storage area 88.

FIGS. 5 A through 5 D show alternative embodiments for the jeep solid cover device. The components are similar but are in a different configuration. Shown are the top pivoting surface/lid 33, the deck 34, a roll bar structure recess/aperture 35 area, a handle means 38—recessed, loop, or the like, a locking means (details not show) 39, a pivot plate means 40 or (side) structure for rotatably securing pivot means 41 and shaft 42 to deck 34, a means 41 for pivoting—hinge means with a shaft 42 and with or without spring and/or dampener for rotation of the lid 33 around the shaft 42 and to/from deck 34, and a manner or means 41A for connecting pivot means 41 to lid 33. The configurations in addition to the preferred embodiment 30 and the prototype 70 are a bi-fold Lid 50 and a side opening lid 51.

FIGS. 6 A through 6 E show an example of hinge and overlap on the jeep hard top cover device. These are shown:

A. From a side/side view 32 of typical jeep with the closed 61 position—1, flat and sealed 61, the rotated 62 position—2, raised and ready to pivot 62, the pivot Position (approximately 45 Degrees) 63—3, mid pivot, partially open, and the pivot Position (approximately 75 to 90 Degrees) 64 4, Full open. The components include the above described top pivoting surface/lid 33, the deck 34, a pivot plate means 40 (side) structure for rotatably securing the deck 34 and lid 33, the roll Bar 85 and roll bar support leg 86, the storage area 88, and a means 46 for securing deck 34 to storage area 88 structure/sides of jeep.
B. From a back view 30A of hard top cover device 30 with the closed 61 position—1, flat and sealed 61, the rotated 62 position—2, raised and ready to pivot 62, the pivot Position (approximately 75 to 90 Degrees) 64—4, Full open top pivoting surface/lid 33. Again shown are the above described top pivoting surface/lid 33, the deck 34, a pivot plate means 40 (side) structure for rotatably securing the deck 34 and lid 33, the roll Bar 85 and roll bar support leg 86, the storage area 88, and a means 46 for securing deck 34 to storage area 88 structure/sides of jeep.
C. From a Section view CC with a side view of deck 34 and lid 33. The components are the above described top pivoting surface/lid 33, the deck 34, a pivot plate means 40 (side) structure for rotatably securing the deck 34 and lid 33, a Slot/Aperture in plate 40A, a pivot shaft 42.
D. From a Section view DD with the top of deck 34 and lid 33 top pivoting surface/lid 33 with the above described top pivoting surface/lid 33, the deck 34, a pivot plate means 40 (side) structure for rotatably securing the deck 34 and lid 33, a means 41 for pivoting—hinge means with a shaft 42 and with or without spring and/or dampener for rotation of the lid 33 around the shaft 42 and to/from deck 34, a manner or means 41A for connecting pivot means 41 to lid 33, and a pivot shaft 42.
E. Section view EE is a view at the seal for the deck 34 and lid 33. This section shows the top pivoting surface/lid 33, the lid labyrinth lip 33A, the deck 34, a deck labyrinth lip 34A, a means for sealing 44 (gasket or the like), a means for securing 45 gasket 44 to deck 34, and a means 46 for securing deck 34 to storage area 88 structure/sides of jeep. Of note, the gasket materials are very well known to those skilled in the art of vehicle covers. The gasket 44 anticipates using rubber, synthetic rubber, plastic, urethane, neoprene or other composite materials to form a contiguous seal between the deck 34 and lid 33 when the lid 33 is in the closed position.

FIGS. 7 A through 7 E show some prototype example 70 of the hard top cover device. With the prototype hardtop jeep cover system 70 is demonstrated the prototype Deck 71, prototype Lid 72, and a prototype Hinge means 73.

FIGS. 8 A through 8 D show sketches of a typical jeep with jeep with roll bars needing a cover device. Shown are a side/side view 32 of typical jeep, a back and perspective sketch 32A of jeep, the roll Bar 85, the roll bar support leg 86, a typical soft cover 87, the storage area 88, and the rear gate/door 89.

FIGS. 9 A through 9 E show various sketches of jeeps configured with roll bars. These figures show various views of general jeep sketch (with short roll bar) 80 and general jeep sketch (with full seating) 81.

FIGS. 10 A through 10 E; FIGS. 11A through 11 F; FIGS. 12 A through 12 D; and FIGS. 13 A through 13 E show prior art attempts to provide solutions to the hard top cover for the storage area on jeeps. This supports the position that the newly invented Clark solid, hard top cover for a Jeep storage area is a unique and patentable invention. Shown are the following: prior art 101 U.S. Pat. No. 5,324,089; prior art 102 U.S. Pat. No. 5,564,768; prior art 103 U.S. Pat. No. 7,438,338; prior art 104 U.S. Pat. No. 8,256,819; prior art 105 U.S. Pat. No. 6,113,179; and prior art 106 U.S. Pat. No. 6,305,730.

The details mentioned here are exemplary and not limiting. Other specific components and manners specific to describing a the solid, hard top cover for a Jeep storage device 30 may be added as a person having ordinary skill in the field of vehicle storage area covers and their uses well appreciates.

### OPERATION OF THE PREFERRED EMBODIMENT

The solid, hard top cover for a Jeep storage device 30 has been described in the above embodiment. The manner of how the device operates is described below. One notes well that the description above and the operation described here must be taken together to fully illustrate the concept of the solid, hard top cover for a Jeep storage device 30. The preferred embodiment is a hard top cover device 30 over a jeep storage area 88 that is comprised of: (a) a deck 34; (b) a means 46 to secure deck 34 to the storage area 88 and structure/sides of jeep; (c) a top pivoting surface/lid 33; (d) a means 41 for pivoting—hinge means with a shaft 42 and with or without spring and/or dampener for rotation of the lid 33 around the shaft 42 and to/from a plane of deck 34; (e) a manner or means 41A to connect pivot means for pivoting 41 to lid 33; (f) a pivot plate means 40 (side structure) for rotatably securing means for pivoting means 41 and the shaft 42 to the deck 34; (g) a means for sealing 44 (gasket or the like) the lid 33 and the deck 34; and (h) a handle 38 and locking 39 means connected to the lid 33 wherein the device may provide a solid top to the storage area of a jeep or of another vehicle protected with roll bars.

The solid, hard top cover for a Jeep storage device 30 operates by unlocking the mechanism 39, lifting the handle 38 and rotating the lid 33 away from the deck 34. The lid 33 rotates about the means 41 which is attached to the pivot plate 40. Once opened, the storage area 88 is available. To close the lid 33, simply reverse the process.

The main use for this storage cover is to address the stated problem. This device 30 alleviates this problem. The problem: Off-road vehicles such as the Jeep® Wrangler® and CJ® are popular among outdoor enthusiasts because of their rugged build and appearance and consequent ability to move over terrain where other vehicles cannot tread. The Wrangler® and CJ® models have open passenger compartments and an open rear compartment. Factory soft storage cover tops are available for these vehicles that can be manually attached to the vehicle with snaps, a belt rail system, locking tabs, and the like to enclose the passenger and rear compartments. Factory tops, however, are cumbersome to install and can require several minutes for complete deployment. Also, they do not afford the security of a lockable hardtop cover as described in this Clark Invention.

FIGS. 2 A through 2 C show the operation and positions of the hard top jeep cover device over storage space. Shown are: From a side/side view 32 of typical jeep in FIG. 2 A with the closed 61 position—1, flat and sealed 61, the rotated 62 position—2, raised and ready to pivot 62, the pivot Position (approximately 45 Degrees) 63—3, mid pivot, partially open, and the pivot Position (approximately 75 to 90 Degrees) 64—4, Full open. The components include the above described top pivoting surface/lid 33, the deck 34, a pivot plate means 40 (side) structure for rotatably securing the deck 34 and lid 33, the roll Bar 85 and roll bar support leg 86, the storage area 88, and a means 46 for securing deck 34 to storage area 88 structure/sides of jeep. And from a back view 30A of hard top cover device 30 in FIG. 2 B and top view in FIG. 2 C show the closed 61 position—1, flat and sealed 61, the rotated 62 position—2, raised and ready to pivot 62, the pivot Position (approximately 75 to 90 Degrees) 64—4, Full open.

With this description it is to be understood that the solid, hard top cover for a Jeep storage device 30 is not to be limited to only the disclosed embodiment of product. The features of the solid, hard top cover for a Jeep storage device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A hard top cover device (30), made of durable materials, over a jeep storage area (88) that is comprised of:
(a) a deck (34);
(b) a means (46) to secure deck (34) to the storage area (88) and structure/sides of jeep;
(c) a top pivoting surface/lid (33);
(d) a means (41) for pivoting the lid (33) around the shaft (42) and to/from a plane of the deck (34);
(e) a means (41A) to connect pivot means for pivoting (41) to lid (33);
(f) a pivot plate means (40) for rotatably securing means for pivoting means (41) and the shaft (42) to the deck (34);
(g) a means for sealing (44) the lid (33) and the deck (34); and
(h) a handle (38) and locking means (39) connected to the lid (33}
wherein the device may provide a solid top to the storage area of a jeep or of another vehicle protected with roll bars.

2. The device according to claim 1 wherein the hinge means is a shaft with a spring.

3. The device according to claim 1 wherein the hinge means is a shaft alone without a spring.

4. The device according to claim 1 wherein the hinge means is a shaft with a dampener.

5. The device according to claim 1 wherein the pivot plate means (40) for rotatably securing means for pivoting means (41) and the shaft (42) to the deck (34 hinge means is a shaft with a spring is a side structure.

6. The device according to claim 1 wherein the means for sealing (44) the lid (33) and the deck (34) is a gasket.

7. The device according to claim 1 wherein the durable materials are from the group consisting of aluminum, anodized aluminum, steel, chrome plated steel, stainless steel, powder coated steel, composite materials and high strength reinforced composite materials.
